(19) United States
(12) Patent Application Publication
(10) Pub. No.: US 2016/0167988 A1
(43) Pub. Date: Jun. 16, 2016

(54) PROCESS FOR REDUCING THE LEVEL OF CHLORIDE IN CHLOROSILANE DIRECT PROCESS HYDROLYZED SUBSTRATE USING MECHANOCHEMICAL TREATMENT

(71) Applicant: Momentive Performance Materials Inc., Waterford, NY (US)

(72) Inventors: David S Schlitzer, Ballston Spa, NY (US); Susan A Nye, Feura Bush, NY (US); Mark Lunden, Ballston Lake, NY (US)

(21) Appl. No.: 14/565,989

(22) Filed: Dec. 10, 2014

(51) Int. Cl. C02F 1/58

(52) U.S. Cl. CPC C02F 1/58; C02F 2101/12

(57) ABSTRACT

The present invention relates to a process for providing a low-chloride hydrolyzate comprising subjecting an acid or base hydrolyzed substrate of a chlorosilane direct process residue to a mechanochemical means to provide a hydrolyzate with a chloride content of less than about 1.1% by weight. The process of present invention is especially useful in cement kilns and smelter operation.

### FIELD OF THE INVENTION

The present invention relates to a process for reducing the level of chloride in a chlorosilane direct process residue hydrolyzed substrate. Particularly, the invention relates to a mechanochemical process for reducing the level of chloride to less than 0.5% by weight on a dry basis.

### BACKGROUND OF THE INVENTION

The manufacture of silicone products generates residue that can present problems in its safe and environmentally acceptable disposal. A variety of methods are known for treating chlorosilane direct process residue. However, there is a persistent high level of chloride in the treated chlorosilane residue.

Methods for reducing the level of chloride in chlorosilane residue are also known. However, chloride levels above 0.1% in the final residue are undesirable for many end uses such as cement kilns or metal recovery smelters. High chloride levels in the treated residue may limit or prevent the use of residue in many end uses. Additionally, financial penalties may be imposed for chlorosilane residues with chloride levels above 0.1%.

### SUMMARY OF THE INVENTION

In accordance with one aspect of the invention, there is provided a process for providing a low-chloride hydrolyzate comprising subjecting an acid or base hydrolyzed substrate of a chlorosilane direct process residue to a mechanical force in the presence of basic materials to provide a hydrolyzate with a chloride content of less than about 1.1% by weight. In certain embodiment, the process of the present invention effectively reduces the level of chloride to less than 0.5% by weight. The treated chlorosilane direct process residue hydrolyzed substrate of the present invention is especially useful in cement kilns and smelter operation.

### BRIEF DESCRIPTION OF THE FIGURE

FIG. 1 is a flowchart of the use of a chlorosilane direct process stream and the subsequent mechanochemical treatment of the chlorosilane direct process residue.

### DETAILED DESCRIPTION OF PREFERRED EMBODIMENTS

The present invention provides a process to effectively reduce the level of chloride in the chlorosilane residue to offer an economical and environmentally sound utilization of the residue stream.

In the specification and claims herein, the following terms and expressions are to be understood as indicated herein below.

It will also be understood that any numerical range recited herein is intended to include all sub-ranges within that range and any combination of end points of said ranges or sub-ranges.

All methods described herein may be performed in any suitable order unless otherwise indicated or clearly contrary to context. The use herein of any and all examples or exemplification language (for example, such as), is intended merely to better illustrate the invention and does not pose a limitation on the scope of the invention unless otherwise claimed. No language in the specification should be construed as indicating any non-claimed element as essential to the practice of the invention.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

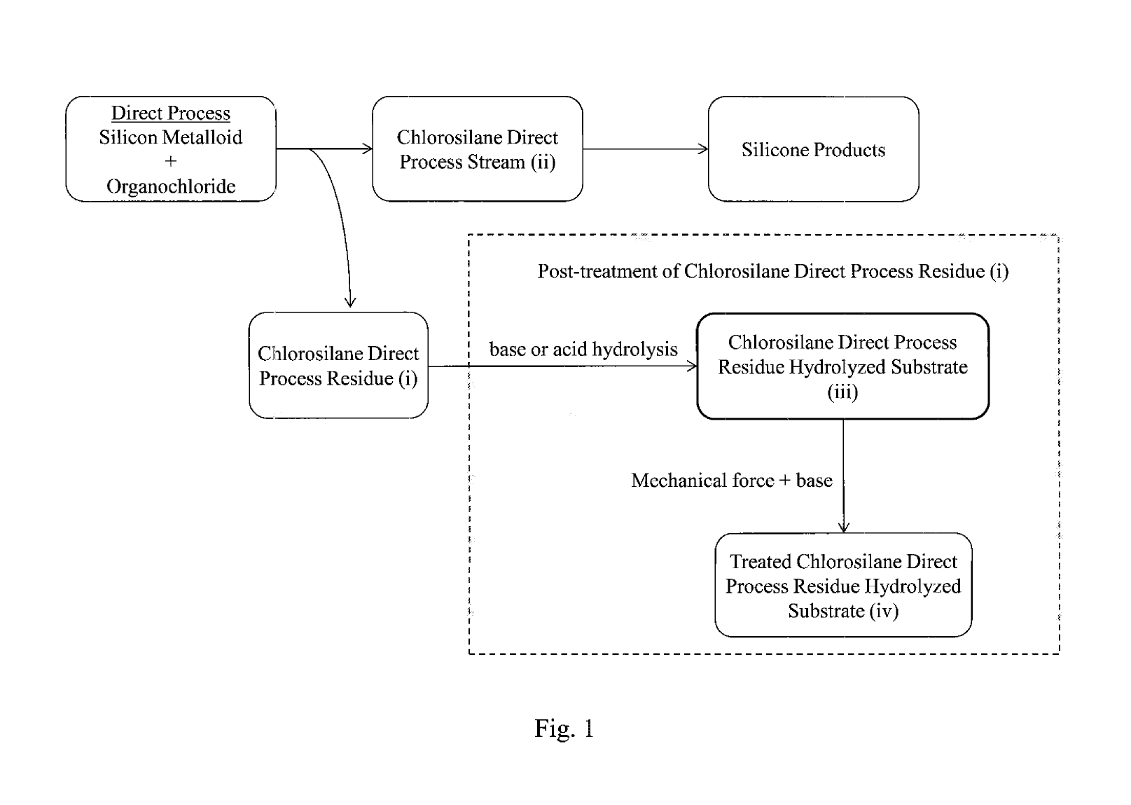

Referring to FIG. 1, chlorosilane direct process residue (i) can be obtained from what is commonly called the “direct process” where silicon metalloid is reacted with organochloride to produce chlorosilane direct process stream (ii) and byproduct chlorosilane direct process residue (i). For example, an organochloride such as methyl chloride is reacted with silicon metalloid to form organochlorosilanes. Chlorosilane direct process residue (i) has little or no commercial value.

Chlorosilane direct process residue (i) can include, for example, high-boiling liquids (>75° C.), distillation residues, chlorosilanes, suspended silicon powder, elevated levels of copper, zinc and tin, as well as a variety of other metals.

The major components of chlorosilane direct process residue (i) are summarized in Table 1. These compositions are considered typical for by-product streams, but considerable batch to batch variation can exist. The liquid portion of the residue may include numerous high boiling multi-functional alkylchlorosilanes, alkylchlorocarbosilanes, alkylchlorosiloxanes and alkylchlorooligosilanes, where the alkyl substituent is predominantly methyl, although others such as ethyl, propyl, may be present. Hydrocarbons and other species may also be present in varying concentrations, but usually at low levels.

TABLE 1
Major Components of Chlorosilane Direct Process Residue (i)

Components
1,1,2-trichloro-1,2,2-trimethyldisilane
1,2-dimethyl-1,1,2,2-tetrachlorodisilane
1,2-dichloro-1,1,2,2-tetramethyldisilane
chloropentamethyldisilane
1,3-dichloro-1,1,3,3-tetramethylcarbodisilane
1,1,3-trichloro-1,3,3-trimethylcarbodisilane
1,3-dimethyl-1,1,3,3-tetrachlorocarbodisilane
1,3-dimethyl-1,1,3,3-tetrachlorodisiloxane
1,3-dichloro-1,1,3,3-tetramethyldisiloxane
1,1,3-trichloro-1,3,3-trimethyldisiloxane
dichlorodimethylsilane
methyltrichlorosilane
dichloroethylmethylsilane
R(CH₃)SiCl₂ + R(CH₃)₂SiCl, wherein R
is ethyl, propyl, butyl, pentyl or hexyl
Solids
Al
Fe
Zn
Cu
Cl

The hydrolysis of chlorosilane direct process residue (i) can be carried out in an acidic or basic medium to produce chlorosilane direct process residue hydrolyzed substrate (iii).

In one embodiment, the acidic aqueous medium comprises an acid selected from HCl and/or HNO₃.

In another embodiment, the basic aqueous medium comprises a base selected from the group consisting of calcium hydroxide, calcium oxide, sodium oxide, sodium hydroxide, potassium oxide, potassium hydroxide, magnesium oxide, magnesium hydroxide, calcium carbonate, calcium bicarbonate, sodium carbonate, sodium bicarbonate, magnesium carbonate, magnesium bicarbonate and combinations thereof.

In one specific embodiment, the process of reducing the level of chloride in chlorosilane direct process residue hydrolyzed substrate (iii) comprises subjecting substrate (iii) to mechanochemical means for a time sufficient to reduce the chloride content to less than 1.1% by weight.

The term “mechanochemical means” refers to the application of intense mechanical force to solid particulates in the presence of a chemical that is capable of removing or reacting with the specie of interest, i.e., basic materials in the present case.

Two mechanical forces were used in this invention: the first was an impact force and the second was a shear force.

Without being bound by theory, it is believed that the application of impact and/or shear in the presence of basic materials presumably reduces the particle size the material which creates new surfaces for moisture and/or basic materials to access trapped chloride. The combination of a mechanical force (e.g., shear and/or impact) coupled with the reactivity of basic materials toward residual chloride in the matrix offers a unique means of lowering the chloride content of the matrix. These mechanical forces may be imparted on the substrate in the wet or dry state with a variety of different types of equipment.

Examples of equipment that can be used in the present invention include milling machines such as ball/pebble mills, jet mills, hammer mills, rod mills, three-roll mills, extruders, kneaders, high shear dispersers, homogenizers, ribbon mixers, double planetary mixers, and rotor stator mixers. A ball mill typically contains milling balls and a milling agent. Milling agents are selected from the group consisting of calcium oxide, slaked lime, calcium hydroxide, sodium oxide, sodium hydroxide, potassium oxide, potassium hydroxide, magnesium oxide, magnesium hydroxide, calcium carbonate, calcium bicarbonate, sodium carbonate, sodium bicarbonate, magnesium carbonate, magnesium bicarbonate and combinations thereof. The ratio of the milling balls to the hydrolyzed substrate is in the range of from 10:1 to 40:1 by weight. The ratio of the hydrolyzed substrate to milling agent is in the range of from 0.64:1 to 155:1 by weight. The process of applying the mechanical force may be performed in a batch or continuous mode.

When shearing force is used, the force is applied for up to 24 hours, more particularly for up to 4 hours.

The base hydrolysis of the DPR stream is described by White in U.S. Pat. No. 5,876,609, Example 5. The duration of each treatment was varied to assess destruction efficiency as a function of time. The process can be carried out in a slurry or dry state.

The process of the present invention is carried out at a temperature in the range of from about 5° C. to about 95° C., more preferably of from 50° C. to 85° C.

The application of the impact force was performed in the solid (dry) state with and without calcium oxide and washed or unwashed base hydrolyzate. The temperature during milling rose to approximately 36-40° C. as a result of close proximity to the motor which achieved a surface temperature of 55-60° C. during milling. When calcium oxide was used the molar ratio was 3-11:1 CaO to Cl. The weight ratio of the balls to the chlorinated substrate was 15-30:1.

In an analogous experiment, the unhydrolyzed DPR was combined with powdered unslaked lime. The mixture was tumbled in the presence of ceramic balls in the hopes of generating a more open gel network than can be obtained from the direct acid or base hydrolysis of DPR. This mixture was then hydrolyzed in hot water with a small amount of lime to maintain a basic pH.

The shearing force was applied with a rotor-stator mixer to the washed base hydrolyzate in the presence of slaked lime slurry or water containing a small amount of slaked lime to provide a basic pH.

Various features of the invention are illustrated by the examples presented below.

### Examples 1-16

### Example 1

A tungsten carbide coated milling chamber (54 cc) was charged with 3 tungsten carbide coated steel balls (10 grams each) and a dried base hydrolyzed MCS residue (1.98 g). The sample was milled in a ball mill for one hour. The resulting solid was washed with 225 g of deionized water, filtered and dried. The chloride level of the dried solid was measured by a sodium/potassium carbonate fusion followed by silver nitrate titration and was found to be 1.1% (75% decrease) from the original value of 4.5%.

### Example 2

A tungsten carbide coated milling chamber (54 cc) was charged with 3 tungsten carbide coated steel balls (10 grams each) and a dried base hydrolyzed MCS residue (2.03 g) and calcium oxide (1.0 g to give a 7× molar excess per chloride). The sample was milled in a ball mill for one hour. The resulting solid was washed with 225 g of deionized water, filtered and dried. The chloride level of the dried solid was measured by a sodium/potassium carbonate fusion followed by silver nitrate titration and was found to be 0.59% (87% decrease) from the original value of 4.5%.

### Example 3

A tungsten carbide coated milling chamber (54 cc) was charged with 3 tungsten carbide coated steel balls (10 grams each) and a dried base hydrolyzed MCS residue (1.0 g at ˜50% solids, i.e. 0.50 g dry basis). The sample was milled with a ball mill for two hours. The resulting solid was washed with 250 g of deionized water, filtered and dried. The chloride level of the dried solid was measured by a sodium/potassium carbonate fusion followed by silver nitrate titration and was found to be 1.75% (63% decrease) from the original value of 4.8%.

### Example 4

A tungsten carbide coated milling chamber (54 cc) was charged with 3 tungsten carbide coated steel balls (10 grams each) and a dried base hydrolyzed MCS residue (1.23 g) and calcium oxide (1.0 g to give a 10.8× molar excess per chloride). The sample was milled in a ball mill for 1¼ hours. The resulting solid was washed with 225 g of deionized water, filtered and dried. The chloride level of the dried solid was measured by a sodium/potassium carbonate fusion followed by silver nitrate titration and was found to be 1.1% (77% decrease) from the original value of 4.8%.

### Example 5

A tungsten carbide coated milling chamber (54 cc) was charged with 3 tungsten carbide coated steel balls (10 grams each) and a dried base hydrolyzed MCS residue (2.00 g) and calcium oxide (1.0 g to give a 3× molar excess per chloride). The sample was milled in a ball mill for seven hours. The resulting solid was neutralized with acetic acid until the pH was less than 7, washed with 225 g of deionized water, filtered and dried. The chloride level of the dried solid was measured by a sodium/potassium carbonate fusion followed by silver nitrate titration and was found to be 0.79% (93% decrease) from the original value of 11.0%.

### Example 6

A 2 L Erlenmeyer flask was charged with a magnetic stirbar, a base hydrolyzed MCS residue (14.23 g), and deionized water (1423 g). The slurry stirred for one hour and was filtered through a Büchner funnel and dried. The chloride level of the dried solid was measured by a sodium/potassium carbonate fusion followed by silver nitrate titration and was found to be 1.5% (86% decrease) from the original value of 11%.

### Example 7

In a glove box was added oven-dried (125° C., overnight) ceramic balls (65.25 g) and unslaked lime (6.69 g, 119 mmol) to a plastic mixing cup (Hauschild, 250 mL). The mixing cup was capped and tumbled on ajar roller (eight hours @80 rpm). The mixing cup was returned to the glove box and DPR (0.47 g, 42% chloride) was added. The mixing cup was capped and returned to the jar roller for 15.5 hours at 80 rpm at ambient temperature (˜25° C.).

### Example 8

A 1200 mL stainless steel beaker equipped with a mechanical stirrer having a 60 mm 4-blade flat blade turbine impeller and a temperature probe was charged with deionized water (473.90 g) and small amount of slaked lime slurry (14.89 g, ˜7% solids) to maintain a basic pH during the hydrolysis. The water-slaked lime mixture was heated to 90° C. on a laboratory hot plate with an impeller speed of 300 rpm. The entire contents of from the plastic mixing cup in Example 7 were emptied into beaker containing the water-slaked lime mixture. The mixture was stirred at 90° C. for two hours and deionized water was added as needed to replace water that evaporated. After allowing the mixture to stir for two hours at 90° C., the mixture was cooled and neutralized with acetic acid until the pH was less than 7. The acidified mixture was filtered with a Büchner funnel and washed with 300 g of deionized water (ca. 1000:1 water:hydrolyzate). The chloride level of the dried solid was measured by a sodium/potassium carbonate fusion followed by silver nitrate titration and was found to be 0.42% (a 99% decrease) from the original 42%.

### Example 9

Deionized water (146.51 g) and slaked lime slurry (SLS, ca 7% solids, 4.09 g) were added to a three-neck 250 mL round bottom flask equipped with a temperature probe, a rotor-stator mixer (IKA T-18 Ultra-Turrax) and a stopper. The flask was immersed in a recrystallization dish filled with ambient temperature water. A base hydrolyzed MCS residue (2.04 g at 52.5% solids, i.e., 1.07 g dry basis) which had been washed with 100× water was added to the flask. The ratio of lime slurry to dry base hydrolyzate was 137 (146.51/1.07). The rotor-stator mixer was started and turned to a set point of 5 (out of 6 maximum. The manual indicates the estimated speed to be 20,000 rpm). The contents were mixed for one hour. The temperature rose from 27° C. to 42° C. over the duration of the experiment. At the end of one hour, the material was filtered through a Büchner funnel. The solid was then washed with water until the pH of the filtrate was 7. The chloride level of the dried solid was measured by a sodium/potassium carbonate fusion followed by silver nitrate titration and was found to be 0.43% (47% decrease) from the original value of 0.81%.

### Example 10

Slaked lime slurry (ca. 7% solids, SLS, 138.42 g) was added to a 250 mL stainless steel beaker equipped with a thermometer and rotor-stator mixer (IKA T-18 Ultra-Turrax). A base hydrolyzed MCS residue (2.62 g at 52.2% solids, i.e., 1.37 g dry basis) which had been washed with 100× water was added to the beaker. The ratio of water to dry base hydrolyzate was 101 (138.42/1.37). The rotor-stator mixer was started and turned to a set point of 4 (out of 6 maximum. The manual indicates the estimated speed to be 15,500 rpm). The contents were mixed for one hour. The temperature rose from 18° C. to 42° C. over the duration of the experiment. (A water/ice bath was periodically used to cool the contents in the beaker.) At the end of one hour, the excess slaked lime was neutralized with glacial acetic acid (ca. 30 mL) and the mixture was filtered through a Büchner funnel. The solid was then washed with water until the pH of the filtrate was 7. The chloride level of the dried solid was measured by a sodium/potassium carbonate fusion followed by silver nitrate titration and was found to be 0.38% (53% decrease) from the original value of 0.81%.

### Example 11

Deionized water (74.84 g) and slaked lime slurry (SLS, ca 7% solids, 3.05 g) was added to a 150 mL glass beaker equipped with a thermometer and a rotor-stator mixer (IKA T-18 Ultra-Turrax). A base hydrolyzed MCS residue (2.02 g at 44.6% solids, i.e., 0.90 g dry basis) which had been washed with 3.5× water was added to the beaker. The ratio of water to dry base hydrolyzate was 83 (74.84/0.90). The rotor-stator mixer was started and turned to a set point of 4 (out of 6 maximum. The manual indicates the estimated speed to be 15,500 rpm). The contents were mixed for one hour. The temperature rose from 18° C. to 42° C. over the duration of the experiment. (A water/ice bath was periodically used to cool the contents in the beaker.) At the end of one hour, the material was filtered through a Büchner funnel. The solid was then washed with water until the pH of the filtrate was 7. The chloride level of the dried solid was measured by a sodium/potassium carbonate fusion followed by silver nitrate titration and was found to be 0.85% (58% decrease) from the original value of 2.00%.

### Example 12

Used a physical equipment set-up similar to Example 9 Slaked lime slurry (189.08 g), substrate (2.05 g at 44.6% solids, i.e., 0.92 g dry basis), rotor-stator mixer setting of 5 which has an estimated speed of 20,000 rpm. An ice/water bath was used to maintain the specified temperature range for one hour. (Table 3). Neutralization of the excess slaked lime and work-up was performed similar to Example 10. The chloride level of the dried solid was measured by a sodium/potassium carbonate fusion followed by silver nitrate titration and was found to be 0.71% (65% decrease) from the original value of 2.00%.

### Example 13

Used a physical equipment set-up similar to Example 9 Slaked lime slurry (209.26 g), substrate (2.92 g at 44.6% solids, i.e., 1.30 g dry basis), rotor-stator mixer setting of 6 which has an estimated speed of 24,000 rpm. A water bath was used to maintain the specified temperature range. The shearing was performed for a four hour period. Neutralization of the excess slaked lime and work-up was performed similar to Example 10. The chloride level of the dried solid was measured by a sodium/potassium carbonate fusion followed by silver nitrate titration and was found to be 0.13% (94% decrease) from the original value of 2.00%.

### Example 14

Slaked lime slurry (ca. 7% solids, SLS, 73.83 g) was added to a 125 mL stainless steel beaker equipped with a thermometer and rotor-stator mixer (IKA T-18 Ultra-Turrax). A base hydrolyzed MCS residue (2.03 g at 50.2% solids, i.e., 1.02 g dry basis) which had been unwashed was added to the beaker. The ratio of water to dry base hydrolyzate was 72 (73.83/1.02). The rotor-stator mixer was started and turned to a set point of 3 (out of 6 maximum. The manual indicates the estimated speed to be 11,000 rpm). The contents were mixed for one hour. The temperature rose from 18° C. to 42° C. over the duration of the experiment. A water/ice bath was periodically used to cool the contents in the beaker. At the end of one hour, the excess slaked lime was neutralized with glacial acetic acid and the mixture was filtered through a Büchner funnel. The solid was then washed with water until the pH of the filtrate was 7. The chloride level of the dried solid was measured by a sodium/potassium carbonate fusion followed by silver nitrate titration and was found to be 0.23% (95% decrease) from the original value of 4.50%.

### Example 15

Hydrolysis in the Presence of the Rotor-stator. A 250-mL 3-necked round bottom flask equipped with a condenser, nitrogen blanket, thermocouple, a rotor-stator mixer (IKA T-18 Ultra-Turrax) and a stopper. The flask was charged with slaked lime slurry (SLS, ca. 7% solids, 186.60 g) and heated to 67° C. with the rotor-stator mixer to a set point of 6 (out of 6 maximum, which has an estimated speed of 24,000 rpm). A pre-dried vial with a septum was charged with direct process residue (DPR). The DPR (10-15 g) was added to the heated SLS via pipet into one of the flask's necks. Much foaming occurred and the temperature rose to 87° C. The reaction continued for four hours while keeping the temperature elevated between 74-86° C. with a heating mantle. After one hour the reaction was cooled and the suspension was treated with acetic acid to dissolve the excess lime. The pasty solid was filtered and washed with deionized water (500 g). The chloride level of the dried solid was measured by a sodium/potassium carbonate fusion followed by silver nitrate titration and was found to be 0.98% (98% decrease) from the original value of 42%.

### Example 16

Hydrolysis in the Presence of the Rotor-stator. A 250-mL 3-necked round bottom flask equipped with a condenser, nitrogen blanket, thermocouple, a rotor-stator mixer (IKA T-18 Ultra-Turrax) and a stopper. The flask was charged with slaked lime slurry (SLS, ca. 7% solids, 185.89 g) and heated to 76° C. with the rotor-stator mixer to a set point of 6 (out of 6 maximum, which has an estimated speed of 24,000 rpm). A pre-dried vial with a septum was charged with direct process residue (DPR). The DPR (9.18 g) was added to the heated SLS via pipet into one of the flask's necks. Much foaming occurred and the temperature rose to 87° C. The reaction continued for four hours while keeping the temperature elevated between 68-86° C. with a hot water bath. After four hours the reaction cooled and the suspension was treated with acetic acid to dissolve the excess lime. The pasty solid was filtered and washed with deionized water (500 g). The chloride level of the dried solid was measured by a sodium/potassium carbonate fusion followed by silver nitrate titration and was found to be 0.23% (99% decrease) from the original value of 42%.

### Comparative Examples 1-4

### Comparative Example 1

A 500 mL Erlenmeyer flask was charged with a magnetic stirbar, a base hydrolyzed MCS residue (3.00 g), and deionized water (300 g). The slurry stirred for one hour and was filtered through a Büchner funnel and dried. The chloride level of the dried solid was measured by a sodium/potassium carbonate fusion followed by silver nitrate titration and was found to be 1.6% (64% decrease) from the original value of 4.5%.

### Comparative Example 2

Slaked lime slurry (ca. 7% solids, SLS) was added to a one quart glass jar along with the hydrolyzate; the quantities are specified in Table 2. The jar was briefly shaken to wet the hydrolyzate solids and the contents of the jar were transferred to a 1 L jacketed glass reactor equipped with a flat-blade impeller (4 blades) powered by a mechanical stirrer. The jacket temperature was adjusted to maintain an internal temperature of 10° C. The mechanical stirrer was operated at 60 rpm. The mixture was agitated at 10° C. for 1 h. The sample was neutralized with glacial acetic acid until the pH was acidic, and the acidified sample was filtered through a Büchner funnel. The chloride level of the dried solid was measured by a sodium/potassium carbonate fusion followed by silver nitrate titration and was found to be 0.57% (87% decrease) from the original value of 4.50%.

### Comparative Example 3

To a four ounce glass jar was added slaked time slurry (ca. 7% solids, SLS, 76.43 g) followed by a base hydrolyzed MCS residue (1.18 g). The jar was capped and the sample was briefly shaken to wet the solids. The mixture was allowed to set at ambient temperature (24° C.) for one hour. The sample was neutralized with glacial acetic acid until the pH was acidic, and the acidified sample was filtered through a Büchner funnel. The chloride level of the dried solid was measured by a sodium/potassium carbonate fusion followed by silver nitrate titration and was found to be 1.03% (77% decrease) from the original value of 4.50%.

### Comparative Example 4

Slaked lime slurry (ca. 7% solids, SLS, 175.84 g) was added to a 1 L jacketed glass reactor equipped with a flat-blade impeller (4 blades) powered by a mechanical stirrer. The jacket temperature was adjusted to maintain an internal temperature of 10° C. The mechanical stirrer was operated at a 600 rpm and the hydrolyzate (2.51 g) was charged to the stirring reactor. The mixture was agitated at 10° C. for 1 h. The sample was neutralized with glacial acetic acid until the pH was acidic, and the acidified sample was filtered through a Büchner funnel. The chloride level of the dried solid was measured by a sodium/potassium carbonate fusion followed by silver nitrate titration and was found to be 0.36% (92% decrease) from the original value of 4.50%.

Table 2 shows results of reducing chloride with impact force on substrates as well as comparative examples where the substrates were washed with 100-fold water.

TABLE 2
Chloride Levels of Milled Substrates

| | | | CaO/Cl | | | | Chloride | |
|---|---|---|---|---|---|---|---|---|
| | | Milling | (mol | Balls/substrate | Temp | Time | (%) | |
| Ex. | Substrate | agent | ratio) | (wt ratio) | (° C.) | (h) | Start | Final |
| 1 | 1412 | None | — | 15 | 37 | 1 | 4.5 | 1.1 |
| 2 | 1412 | CaO | 7 | 15 | 34 | 1 | 4.5 | 0.59 |
| 3 | 1406 | None | — | 30 | 38 | 2 | 4.8 | 1.75 |
| 4 | 1406 | CaO | 10.8 | 24 | 39 | 1.25 | 4.8 | 1.1 |
| 5 | 1411 | CaO | 3 | 15 | 36 | 7 | 11 | 0.8 |
| 6 | 1411 | — | — | — | 25 | — | 11 | 1.5 |
| 7 | DPR | CaO | 21 | 9.1 | 25 | 15.5 | 42 | N/A |
| Com. 1 | 1412 | — | — | — | 25 | — | 4.5 | 1.6 |

Table 3 shows results of reducing chloride with shearing force on substrates. The results suggest the application of a shearing force to a slurry state is more effective than the impact force obtained on the dry solids. The results from the shear experiments demonstrate shearing in the presence of a slaked lime slurry provides improved removal of chloride from the substrate in all cases when compared to shearing in the presence of water with a small amount of lime.

Due to the modest reduction of chlorides by shearing the hydrolyzates, the hydrolysis of the DPR was performed in the presence of shear. Table 3 (Ex. #15 and #16) shows the results of two experiments conducted in this manner.

TABLE 3
Chloride Results from Shearing Experiments.

| | | | Reagent/ | | | | Chloride | |
|---|---|---|---|---|---|---|---|---|
| | | | Substrate | Temp. | Freq. | Time | (%) | |
| Ex. | Substrate | Reagent | (w/w) | (° C.) | (Hz) | (h) | Start | Final |
| 8 | Ex. 7 | Water | 66 | 85-92 | 5 | 2 | 42 | 0.42 |
| 9 | 1463 | Water | 137 | 27-42 | 333 | 1 | 0.81 | 0.43 |
| 10 | 1463 | SLS | 101 | 9-17 | 258 | 1 | 0.81 | 0.38 |
| 11 | 1446 | Water | 83 | 18-51 | 258 | 1 | 2.00 | 0.85 |
| 12 | 1446 | SLS | 206 | 10-17 | 333 | 1 | 2.00 | 0.71 |
| 13 | 1446 | SLS | 160 | 20-51 | 400 | 4 | 2.00 | 0.13 |
| 14 | 1412 | SLS | 72 | 7-18 | 183 | 1 | 4.5 | 0.23 |
| 15 | DPR | SLS | 10 | 67-87 | 400 | 1 | 42 | 0.98 |
| 16 | DPR | SLS | 20 | 68-86 | 400 | 4 | 42 | 0.23 |
| Com. 2 | 1412 | SLS | 70 | 10-12 | 1 | 1 | 4.5 | 0.57 |
| Com. 3 | 1412 | SLS | 65 | 20-25 | 0 | 1 | 4.5 | 1.03 |
| Com. 4 | 1412 | SLS | 70 | 8-12 | 10 | 1 | 4.5 | 0.36 |

The combination of a mechanical force (e.g., shear or impact) coupled with the reactivity of slaked lime toward residual chloride in the matrix offers a unique means of lowering the chloride content of the matrix. This effect is evident in the ball milling of DPR base hydrolyzates shown in Table 2: examples 1 vs. 2 compared to a standard washing of the product, comparative example 1; example 3 vs. 4. Substrate treatment under high shear conditions shows lime is more effective at lower shear rates than water at higher shear rates (examples 9 vs. 10). A similar trend is observed between examples 11, 12 and 13. Likewise, the use of slaked lime slurry shows a progressive decrease in residual chloride levels as a function of shear rate, example 14 and comparative examples 2-4.

These examples are to be construed as exemplary in nature only and are not intended in any way to limit the appended claims. It is contemplated that a person having ordinary skill in the art would be able to produce obvious variations of the subject matter and disclosures herein contained that would be by reason of such ordinary skill within the literal or equitable scope of the appended claims.

What is claimed is:

1. A process for providing a low-chloride hydrolyzate comprising subjecting an acid or base hydrolyzed substrate of a chlorosilane direct process residue to a mechanical force in the presence of basic materials to provide a hydrolyzate with a chloride content of less than about 1.1% by weight.

2. The process of claim 1 wherein the process is carried out in a slurry.

3. The process of claim 1 wherein the process provides for a hydrolyzate with a chloride content of less than about 0.5% by weight.

4. The process of claim 1 wherein the mechanical force is impact force.

5. The process of claim 1 wherein the mechanical force is shearing force.

6. The process of claim 1 wherein the basic materials are selected from the group consisting of calcium oxide, slaked lime, oxides and hydroxides of lithium, sodium, potassium and cesium, oxides, hydroxides, carbonates and bicarbonates of magnesium and calcium, and mixtures thereof.

7. The process of claim 1 wherein the chlorosilane direct process residue contains at least one member selected from the group consisting of 1,1,2-trichloro-1,2,2-trimethyldisilane, 1,2-dimethyl-1,1,2,2-tetrachlorodisilane, 1,2-dichloro-1,1,2,2-tetramethyldisilane, chloropentamethyldisilane, 1,3-dichloro-1,1,3,3-tetramethylcarbodisilane, 1,1,3-trichloro-1,3,3-trimethylcarbodisilane, 1,3-dimethyl-1,1,3,3-tetrachlorocarbodisilane, 1,3-dimethyl-1,1,3,3-tetrachlorodisiloxane, 1,3-dichloro-1,1,3,3-tetramethyldisiloxane, 1,1,3-trichloro-1,3,3-trimethyldisiloxane, dichlorodimethylsilane, methyltrichlorosilane and dichloroethylmethylsilane.

8. The process of claim 1 wherein the chlorosilane direct process residue contains at least one member selected from the group consisting of R(CH₃)SiCl₂ and R(CH₃)₂SiCl, wherein R is ethyl, propyl, butyl, pentyl or hexyl.

9. The process of claim 1 wherein the process is carried out at a temperature in the range of from about 5° C. to about 95° C.

10. The process of claim 1 wherein the process is carried out at a temperature in the range of from 50° C. to 85° C.

11. The process of claim 4 wherein the impact force is produced in a milling machine containing milling balls and at least one milling agents.

12. The process of claim 11 wherein the milling agents are selected from the group consisting of calcium oxide, slaked lime, oxides and hydroxides of lithium, sodium, potassium and cesium, oxides, hydroxides, carbonates and bicarbonates of magnesium and calcium, and mixtures thereof.

13. The process of claim 11 wherein the ratio of the milling balls to the hydrolyzed substrate is in the range of from 10:1 to 40:1 by weight.

14. The process of claim 11 wherein the ratio of the hydrolyzed substrate to milling agent is in the range of from 0.64:1 to 155:1 by weight.

15. The process of claim 5 wherein the shearing force is applied for up to 24 hours.

16. The process of claim 5 wherein the shearing force is applied for up to 4 hours.
